(19) United States
(12) Patent Application Publication
(10) Pub. No.: US 2005/0261964 A1
(43) Pub. Date: Nov. 24, 2005

(54) Method and system for receiver self-priced multimedia communication over the internet and a member pool via a plug-in module compatible with any Instant messaging software

(76) Inventor: Kuo Chun Fang, Taipei (TW)

Correspondence Address: WHITE-WELKER & WELKER, LLC, P.O. BOX 199, CLEAR SPRING, MD, 21722-0199, US

(21) Appl. No.: 11/182,909

(22) Filed: Jul. 15, 2005

Related U.S. Application Data
(63) Continuation-in-part of application No. 10/860,858, filed on Jun. 4, 2004.
Application No. 10/860,858 is a continuation-in-part of application No. 10/831,857, filed on Apr. 26, 2004.
(60) Provisional application No. 60/481,678, filed on Nov. 20, 2003.

(51) Int. Cl. G06F 17/60

(52) U.S. Cl. 705/14

(57) ABSTRACT

The present invention accomplishes billing and collection of multimedia IP calls with receiver designated fee schemes, enabling advance services such as personal 800 or 900 service in the conventional telephony via a downloadable software plug-in that is compatible with any compatible instant messaging software. Internet users register as members via member sub-system, and acquire a unique member ID across the member pool by downloading and installing client-software, and login to the communication sub-system and enter a “stand-by for communication” mode. Member chooses a fee flow method among options of “pay-to-answer (PA)”, “charge-to-answer (CA)”, and “free-to-answer (FA)”, and set member's own per-pulse fee rate. Callers find the right receiver by entering keywords in a search box within their IM space or by going through a refined search utilizing such keys as country zip codes, keywords, or fee schemes. Results are returned in a search result page in several variations, preferably: pay-to-answer first, and higher rate on top; free-to-answer, then, lower rate on top; and charge-to-answer, then lower rate on top. The higher advertisers such as pay-to-answer providers are rewarded with more call icons appearing in a higher position. The search engine sells advertisements with its search results pages and receives a portion of the IM fee flows from a successful connection.

### CROSS REFERENCE TO RELATED APPLICATIONS

This application is a continuation in part of U.S. patent application Ser. No. 10/860,858, entitled “Method and System for Receiver Self-priced Multimedia Communication Over the Internet and a Member Pool Incorporating Advertising Placement in Conjunction with a Search Engine”, filed on Jun. 6, 2004 which is a continuation in part of U.S. patent application Ser. No. 10/831,857, which claims benefit of U.S. Provisional Patent Application Ser. No. 60/481,678.

This application is a continuation in part of U.S. patent application Ser. No. 10/831,857, entitled “Method and System for Receiver Self-priced Multimedia Communication Over the Internet and a Member Pool”, filed on Apr. 26, 2004, which claims benefit of U.S. Provisional Patent Application Ser. No. 60/481,678.

This application cross-references U.S. Provisional Patent Application Ser. No. 60/481,678, entitled “Method and System for Receiver Self-priced Multimedia Communication Over the Internet and a Member Pool”, filed on Nov. 20, 2003.

This application cross-references Taiwan Patent Application SN 092132211, entitled “Method and System for Receiver Self-priced Multimedia Communication Over the Internet and a Member Pool”, filed on Dec. 1, 2003.

This application cross-references China Patent Application SN 2003/101225324, entitled “Method and system for multimedia communication over the Internet and a Member Pool”, filed on Dec. 12, 2003.

### SEQUENCE LISTING OR PROGRAM

Not Applicable

### FEDERALLY SPONSORED RESEARCH

Not Applicable

### TECHNICAL FIELD OF THE INVENTION

This invention relates to multimedia communications over the Internet, and more specifically relates to a receiver self-priced fee scheme for the determination of fee flow, the billing and collection of fees between the caller and receiver, and the incorporation of search engine technology into the multimedia communications system for easier location of desired receivers.

### DEFINITION OF TERMS

Member/Member Pool, the member pool is comprised of one or more members, who are registered to use the system.

Caller/Receiver, a caller is any member who initiates a call, and the receiver is any member who accepts a call.

Payer/Payee, a payer is any member who makes payment for a receivers services and the cost of the call, while the payee is any member who receives payment for accepting a call.

Fee Flow/Charge-to-Answer is any call that requires a caller to pay for contacting any receiver.

Fee Flow/Free-to-Answer is any call that requires no payment by the caller.

Fee Flow/Pay-to-Answer is any call that requires a caller to pay for contacting any receiver, where the receiver can add virtually unlimited incentives into the terms to attract other members to make a call.

Fee Flow Participation is the scheme for one or more parties to benefit from the fee flow of a completed call with fee flow.

Fee Flow Participant is one or more parties entitled to participate in a fee flow participation.

Online Presence is the critical factor for a call to be established and charged, and it can be un-manned or automated, human presence is not required.

Pay-per-Call is a flat, one-time fee, set for a call.

Pay-per-Clock is a flexible fee that is calculated based on the duration of a call.

Pay-per-Performance occurs when the Payer gives payment, in the form of a tip, to the Payee upon the completion of a call, in addition to all other fee flows, either in conjunction with or in place of a rating system.

Pay-per-View is a flat, one-time set fee for a non-manned, auto-answered call, featuring a live feed for multimedia streaming of audio-visual content.

Pay-per-Download is a flat one-time fee set for a non-manned, auto-answered call, featuring download of one or more files.

Pay-per-Game is a flat or flexible fee, calculated for a call, featuring a real-time game.

Advertiser(s) and Advertising Member(s) are those subscribed to one or more keywords waiting to be short-listed and clicked to be engaged as a Receiver.

Respondents are any members who initiate a call in response to an advertiser's advertisement placement.

Keyword(s) match is the matching keyword(s) subscribed by advertising member(s) with the keyword(s) used in a search session that generates a short-list advertisement placement.

### BACKGROUND OF THE INVENTION

For return on investment (ROI) concerns, traditional telephone companies bill and collect telephone charges from their subscribers under one of these well known schemes: Caller pay, Receiver pay, and Both Caller and Receiver pay. Telephone companies will design various rate plans for customers to subscribe, these rate plans are usually regulated and subject to the approval of regulatory bodies, and are integral parts of service contracts between telephone companies and subscribers.

Among all the telephony products and rate plans, Premium Rate Services (PRS) have evolved since the early 1980's, whilst telephone companies engage third party service providers to provide value-added service via the telephone infrastructure, callers will have to pay a premium rate to gain access to these services. The receiver (provider) of a PRS call is the only party that is granted the contractual right to share the telephone charges that telephone companies collect from subscribers.

It is also normal to see that rate plans are not always call related, therefore basic service charges are common, meaning some price is to be paid for being just “connected” regardless of whether calls are made of not. In recent years, flat monthly fee plans are gaining popularity, while subscribers pay a flat fee and can make as many calls as he/she please without incurring additional per-call charges.

The latest evolution of communications over IP has enabled point-to-point as well as pooled multimedia communications without relying on the switch systems built by telephone companies for the call routing and exchange, and therefore also detached such communications from the billing and collection systems that the telephone companies built over their subscriber bases. The IP network builders need to take different approaches to address the needs to price and collect fees to make the facilitating of communications over IP networks a viable business.

For example, U.S. Pat. Nos. 6,223,165 and 6,523,010 issued to Lauffer both teach a method of and an apparatus for facilitating the delivery of advice to consumers using a server unit that can store and display the names and characteristics of experts and then rapidly assist in connecting the expert and consumer for real-time communication. The server can also have the ability to receive keywords from the consumer, match those keywords to one or more experts, and tell the consumer how to contact an expert.

U.S. Pat. No. 6,801,899 issued to Lauffer teaches techniques for delivering information electronically and, more particularly, for delivering advice to consumers from a diverse set of experts. Lauffer also teaches systems and methods for matching consumers' questions with experts, displaying available experts for consumer viewing and selection, providing for compensation from consumers to experts, and providing for the connection between consumer and experts.

U.S. Pat. No. 6,865,540 issued to Faber, et al. teaches a method and apparatus for implementing group calling that includes displaying a service provider, a service provider rate for communicating with the service provider, and a real-time indication of whether the service provider is available. The method taught includes the steps of: receiving a request from a first customer to communicate with the service provider and connecting the first customer to the service provider through a link capable of transmitting from the service provider to the first customer, receiving a request from a second customer to communicate with the service provider and connecting the second customer to the service provider through a link capable of transmitting from the service provider to the second customer while the first customer is coupled to the service provider, billing the first customer automatically based on the time during which the link to the first customer is maintained; and billing the second customer automatically based on the time during which the link to the second customer is maintained.

As observed in the marketplace, IP network builders or providers were still limited to the convention wisdoms of the old telephony industry. Users are given very no choice to leverage on their knowledge base to transform the perceived value in multimedia enhanced IP communications into financial benefit, not to mention the opportunity to participate in an open market for the acquisition of useful digital contents from sources that price their contents in a competitive fashion.

Another marketplace observation is the continual struggle that Instant Messaging (IM) service providers are experiencing trying to realize a positive return on their investment into VoIP. The marketplace is extremely competitive, competitors like Skype, offering “free internet telephony that just work” and other using free services like Microsoft's web conferencing and meeting software to engage in phone calls from personal computers to other personal computers located anywhere, connected by the Intranet. What is needed is a business method and model that provides additional features to its users rather than replacing conventional phone service at a much-reduced price, while offering its providers one or more revenue streams.

More and more frequently Internet users are using search engines to find desired information and points of contact for specific topics or assistance with problems. The multimedia communications system of the present invention is adaptable to integration into the current search engine methodology which utilizes paid advertising in exchange for prime ad placement on a displayed web page in response to a users search, and the relevance of listed advertising member is established via matching the keyword(s) used by the users in a search with the key word(s) subscribed by the advertising member.

### SUMMARY OF THE INVENTION

The present invention accomplishes billing and collection of multimedia IP calls with Receiver designated fee schemes, and thereby enables such advance services as personal 800 or 900 service in the conventional telephony. Moreover, what goes beyond the telephony conventions is that with “Pay-to-Answer” option, the receiver can add virtually unlimited incentives into the terms to attract other members to make that call.

People involved in any communications (e.g. Instant Messaging over the internet) incur opportunity cost of the “time” and “perceived value of content”: The method and system empowers any member being called (as a receiver) to monetize these opportunity costs and realize financial benefits derived from the communication session. The present invention addresses the above stated needs by providing a capability to perform Receiver Self-priced multimedia communications via the IP network and over a member pool.

The Receiver Self-priced scheme allows a registered member to apply a pre-determined fee scheme comprising “fee flow” and “per-pulse rate” parameters in answering a call via an Internet connected device with installed client software. Depending on the receiver's designated fee flow, one of the parties involved in the communication will benefit from the transfer of monetary values of tokens, in an amount calculated in accordance with the receiver designated per-pulse rate.

Adopting the open market principle, members are free to choose an applicable fee flow with three options when members answer calls, namely “Pay-to-Answer”, “Free-to-Answer” and “Charge-to-Answer”. The options members chose will place the member in the marketplace as either a “Buyer”, “Neutral Player” or “Seller”. When a call is placed and answered, the main service contract is established between the caller and receiver, and fees are calculated and transferred between members, while the system servers as an intermediary, and collect a part of the fee flow as the reward with the nature being a commission.

The multimedia communications system of the present invention can be incorporated into a search engine to assists callers in locating the right person or receiver of the call to provide them with the best answer to their questions. Search engine sell keyword advertisements within their search result pages, but with the multimedia communications system of the present invention search engines can not only collect fees for advertisement placement, they can collect additional fees by charging a small percentage of the fee payment for each individual connection they are credited in delivering to the payee in a communication session.

Additionally, the billing and collection system of the present invention can incorporate a prepaid fee account in response to a member's necessity to have a find that can be used to pay for services as they occur and enable credit transfers between members for usage beyond the multimedia communications system fee flows. This prepaid account would operate more like a distributor of money or a payment gateway on a multi-user electronic network. The prepaid account may also allow for an escrow feature that enables a member to hold the transfer of a payment for any number of days or until further action is taken. The prior art has yet to address payment methods they work in unison with instant messaging services or are complementary to services offered over other such multimedia communication systems.

### BRIEF DESCRIPTION OF THE DRAWINGS

FIG. 1 illustrates the system diagram of the present invention;

FIG. 2 illustrates the workflow process of member sub-system of the present invention;

FIG. 3 illustrates the workflow process of the communication sub-system of the present invention;

FIG. 4 illustrates the workflow process of the clearing sub-system of the present invention;

FIG. 5 illustrates the simplified workflow process of the transaction sub-system of the present invention;

FIG. 6 illustrates a call scenario and fee flow example of the present invention;

FIG. 7 illustrates the difference between a standard search engine results page and the search results page of the present invention;

FIG. 8 illustrates the hierarchy of the preferred embodiment of the present invention for the receivers returned for a given search.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a method and process for enabling multimedia communications over a multi-user electronic network such as the Internet, which incorporates a receiver self-priced fee scheme for the determination of fee flow and the billing and collection of fees between the caller and receiver. Multimedia communications includes communication through instant messaging systems, other text messaging systems either instant or delayed, and voice communications systems either instant or delayed.

The multimedia communication system of the present invention is not specific to a single channel of communication over a multi-user electronic network, although the preferred embodiment incorporates uses instant messaging (IM). The major system elements consist of database server, multiple subsystems, and multiple users connected over a multi-user electronic network.

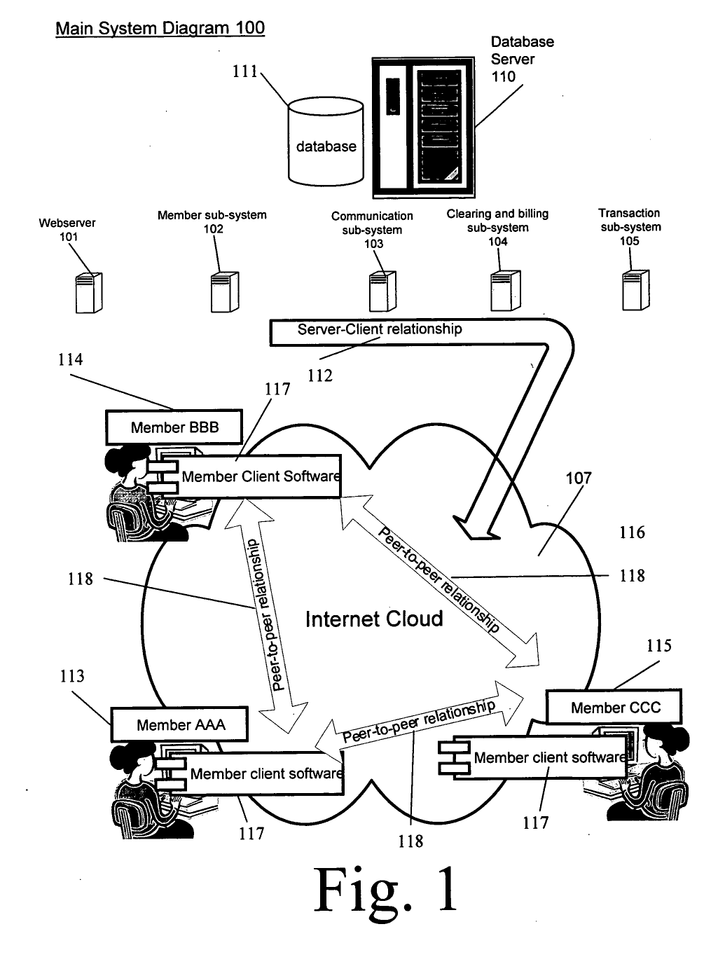

The mechanics of the processes and activities discussed above can be achieved using the conceptual model of FIG. 1. FIG. 1 represents the main system diagram (100) of the present invention. The physical system consists of a database server (110) that contains information in a database (111). The database server (110) also includes a webserver (101) which enables members (113, 114, and 115) to interact with the system software, a member sub-system (102) for processing and storing member information, a communication sub-system (103) that enables members (113, 114, and 115) to interact with each other and engage in multimedia communications, a clearing and billing sub-system (104) that provides for efficient billing, payment, and fund transfer, and a transaction subsystem (105) for enabling, recording, and effectuating online transactions between members and between members and system (113, 114, and 115). The database server (110) and its systems are connected to members via multi-user network, also referred to as an Internet Cloud (107) that establishes a server-client relationship between the database server (110) and members.

Via the Internet Cloud (107) members (113, 114, and 115) downloads and installs client-software (117), and login to the communication sub-system (103) and enter a “stand-by for communication” mode. The client software (117) enables members (113, 114, and 115), via the Internet cloud (107), to communicate directly with other users in a peer-to-peer relationship (118).

In an alternative embodiment of the present invention, the client-software (117) is in the form of a plug-in, which is well known in the prior art. When a user downloads the client-software (117) in plug-in format, s/he may load the client-software (117) on their machine as a plug-in software for any other compatible instant messaging software previously installed on their computer or other electronic device such as a cell phone or PDA. In such a complementary position, the fee flow between members is more easily enabled and the accessibility of the members to the member network in dramatically increased.

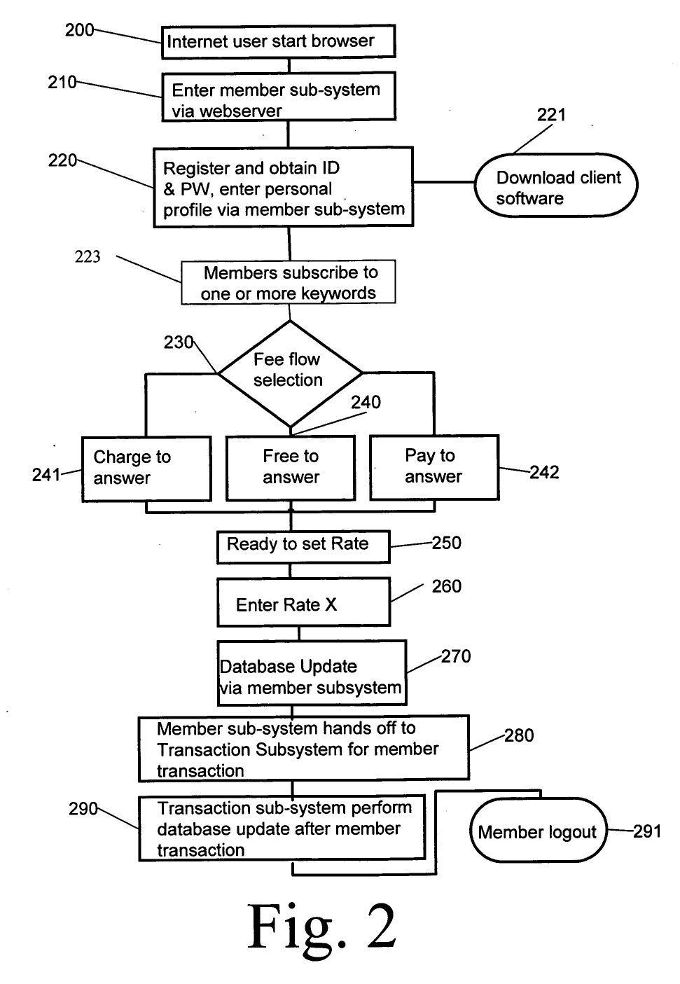

FIG. 2 illustrates the workflow of the member subsystem (102) that a member experiences when first registering for the system or returning to offer or purchase services. In the first step a member starts their Internet browser (200) to access the Internet could (107). Next the member enters the subsystems via the webserver (101). Once a member accesses the webserver (101), they may register and obtain a unique ID, password, and enter personal information (220) via the member subsystem (102) in addition to subscribing to one or more keywords (223) to establish relevance with keywords to be quarried by search engine users.

If the member has not downloaded the client software (221), they may do so at this point. Next, each member chooses a fee flow method (230) among options of “Pay-to-Answer (PA)” (242), “Charge-to-Answer (CA) (241)”, and “Free-to-Answer (FA) (240)”. Now the member is ready to set their own per-pulse fee rate (250) and does so by entering their desired rate (260). Once a member enters their desire rate (260), the database (111) is updated (270) via the member subsystem (102). The member subsystem (102) then hands off to the transaction subsystem (105) for process of the member transaction (280). The transaction subsystem (105) performs the database update (290) after the member transaction and the member logs out (291) upon completion.

In yet another embodiment of the multimedia communication system of the present invention multiple fee schemes for each member base on keyword searches completed on search engines or channel sensitivities of Internet portals are possible. Members may sign up for each fee scheme previously described and associate them with any number of keywords (223) or a groups of keywords. Additionally, members may sign up for each scheme associated with a channel division offered by an Internet portal.

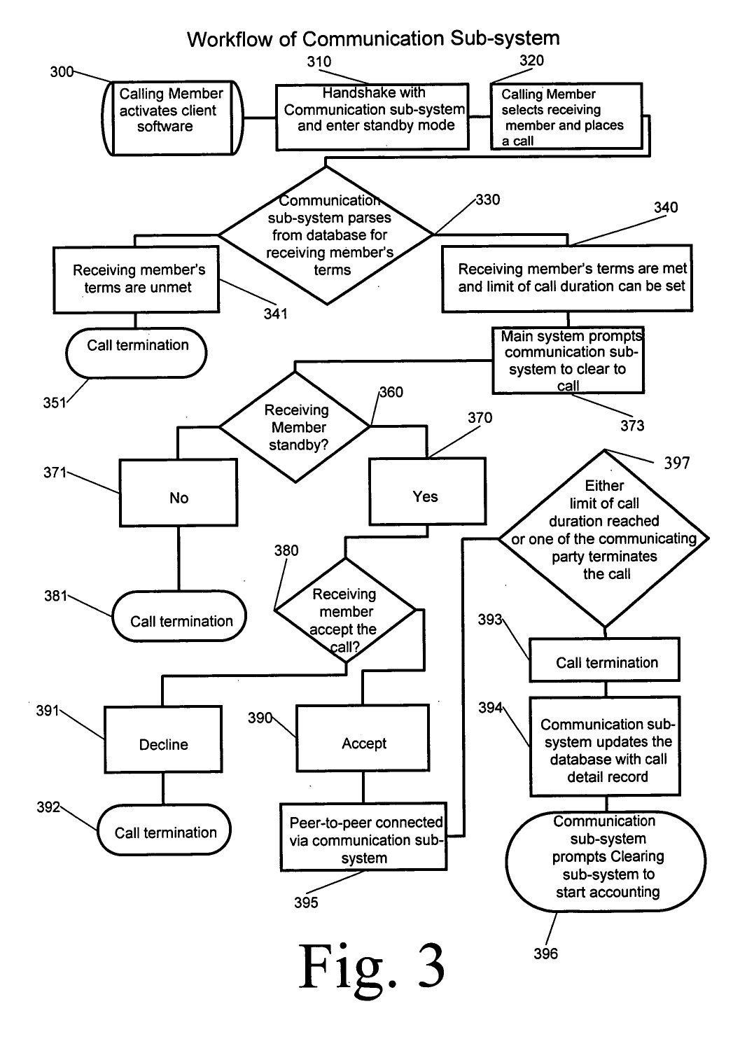

Now referring to FIG. 3 the workflow of the communication subsystem (103) is illustrated. First, the calling member activates the client software (300) and a handshake authentication process activates the communication subsystem (103) and places the system enters into a standby mode (310) waiting the call member's selection. Next the calling member selects a receiving member and places a call (320). The communication subsystem (103) then parses from the database (111) the receiving member's terms and determines whether they are met or unmet (330). If the terms are unmet (341) then the call is terminated (351). If the receiving member's terms are met (340), then a limit on call duration can be set.

The main system on the database server (110) prompts the communication subsystem (103) to clear receivers line to receive call (373). The communication subsystem (103) determines if the receiving member is ready to receive the call (360). If the receiving member is not ready (371) then the call is terminated (381). If the receiving member is ready to receive the call (370) the call is sent and the receiving member must then determine if they want to attempt the call (380). If the receiving member declines (391) the call is terminated (392). If the receiving member accepts (390) the call is connected by the communication subsystem (103) via a peer-to-peer connection (395).

Upon one party terminating the call or the expiration of the call limit duration (397), the call is terminated (393) and the communication subsystem (103) updates the database (111) with call details to create a record (394) and then the communication subsystem prompts the clearing subsystem (104) to start the accounting process (396). Call details may include, but are not limited to, a rating mechanism.

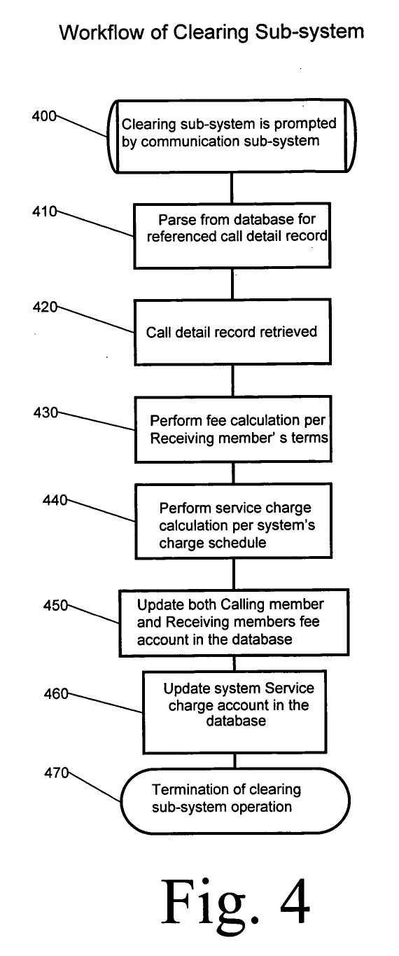

Now referring to FIG. 4 the workflow of the clearing subsystem (104) is illustrated. The clearing subsystem (104) is prompted by the communication subsystem (103) to initiate the process (400). The clearing subsystem (104) then parses from the database (111) to obtain a referenced call detail record (410) and retrieves said call detail record (420). Next the clearing subsystem (104) performs a fee calculation following the receiver member's terms (430) and performs a service charge calculation (440) per system's charge schedule. Then both the calling and receiving member's fee accounts in the database (111) are updated (450), the system's service charge account is updated (460), and the clearing subsystem operation is terminated (470).

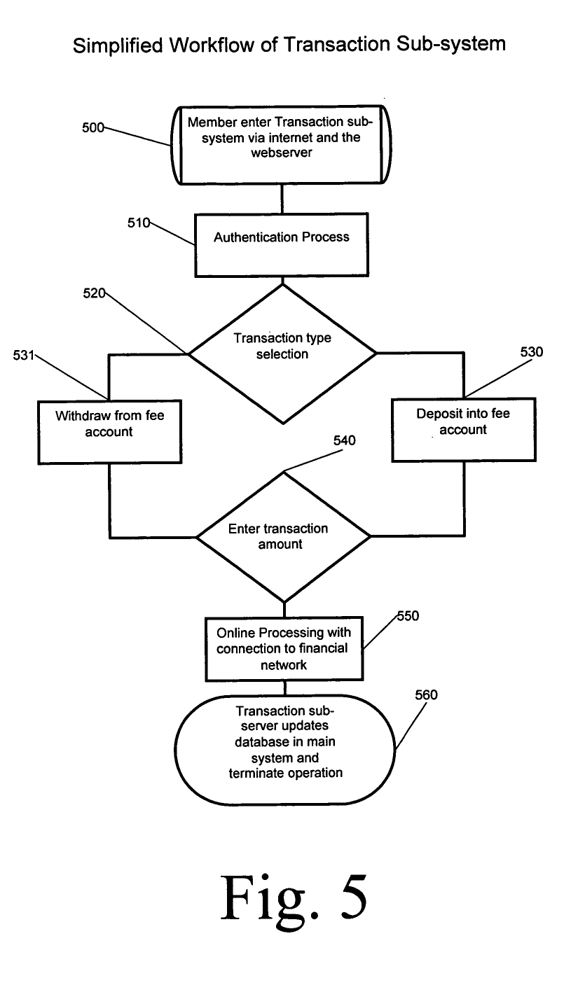

FIG. 5 illustrates the simplified workflow of the transaction subsystem (105). A member enters the transaction subsystem (105) via a multi-user electronic network such as the Internet using the webserver (101) to start the process (500). Next an authentication process occurs (510) and a transaction type is selected by the member (520). The member can either elect to withdraw funds from the fee account (531) or deposit funds into the fee account (530). Fund amounts for the desired withdraw or deposit is entered (540) and the transaction is processed online in connection with a financial network (550). Finally, the transaction subsystem (105) updates the database (111) and terminates the operation (560).

When receiving a call a member may or may not be required to deposit money into their fee account. Depending on a member's chosen fee scheme, in case of a CA member, the call can be answered without having to deposit a stored value into members fee account, because fee will flow from caller to receiver, and benefit the receiving member. In case of a PA or FA fee flow methods, the member will have to purchase, via transaction sub-system (105), and deposit into the stored-value fee account, in order to fulfill the fee flow paying to the caller and system.

When making a call a member may or may not be required to deposit money into their fee account. Depending on the Called (receiving) member's chosen fee scheme, in case of a PA or FA call, calling member can be cleared for the call, cause the calling party will benefit from the call and there is no need for the caller to pay any fee. In case of a CA call, the calling member will have to purchase via transaction sub-system (105) and deposit into the stored-value fee account, in order to fulfill the fee flow paying to the called (receiving) member and system.

The transaction system of the present invention create a fee flow between caller and receiver under all pay schemes and one alternative to requiring callers to deposit money into an account is to offer prepaid accounts. The use of prepaid accounts can also be leveraged to enable credit transfers between members for usage beyond the multimedia communication fee flows. In this embodiment, the multimedia communication system of the present invention can provide a transaction system that acts more like a distributor of money with other systems can accept as payment.

In yet another embodiment, the prepaid fee account can be converted into a payment gateway that other providers on the multi-user electronic network may adopt for accepting or making payments through their own individual systems.

In still another embodiment, the fee account can incorporate an escrow feature that will enable a member to place a hold on a transfer for any number of days until further notice is taken. This functionality servers to incorporate an escrow service into multimedia communications systems such as instant messenger over a multi-user electronic network such as the Internet which has not to be done in the prior art.

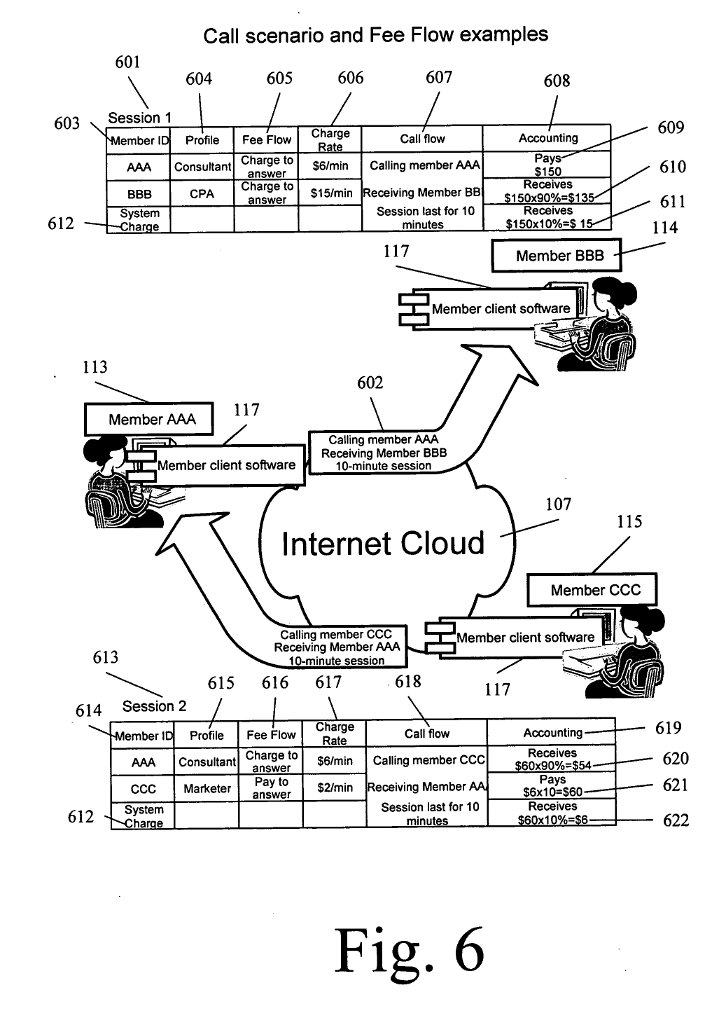

Now referring to FIG. 6 a call scenario and fee flow example is given. Call session 1 (601) Member AAA (113) utilizes the member client software (117) to contact Member BBB (114) through the Internet cloud (107). The member subsystem (102) contains the member IDs (603), profiles (604), fee flow selections (605) and rate information (606). The communication subsystem (103) controls the call flow (607), initiation, duration, and termination. When the call is completed the clearing subsystem (104) performs the calculations to determine the flow of payment and the system charge (608). In session 1 (601) the calling Member AAA (113) initiated a 10-minute session (602) with Member BBB (114). According the member and system rates, this call cost Member AAA (113) $150 (609), with the system taking a 10% system charge (612) of $15 (611) and then passing the remainder of the payment, $135, (610) along to Member BBB (114).

FIG. 6 also illustrates a second session (613) where Member CCC (115) utilizes the member client software (117) to contact Member AAA (113) through the Internet cloud (107). The member subsystem (102) contains the member IDs (614), profiles (615), fee flow selections (616) and rate information (617). The communication subsystem (103) controls the call flow (618), initiation, duration, and termination. When the call is completed the clearing subsystem (104) performs the calculations to determine the flow of payment and the system charge (619). In session 2 (613) the calling Member CCC (115) received a 10-minute session (602) with Member AAA (113). According the member and system rates, this call cost Member CCC (115) $54 (620), with the system taking a 10% system charge (612) of $6 (621) and then passing the remainder of the payment, $60, (622) along to Member AAA (115).

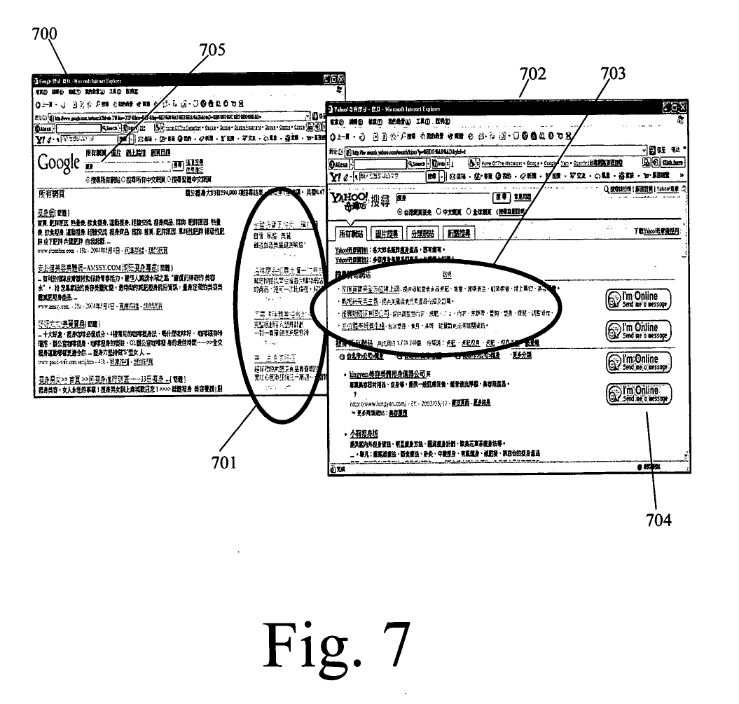

Now referring to FIG. 7 a typical keyword search (700) for a known search engine in the prior art is illustrated in comparison to the desired search results (702) and page positioning for an improved search engine. In a typical search engine known in the prior art callers can find the right person or receiver by entering a keyword in the search box (705) within the IM system or by going through a refined search process.

One of ordinary skill in the art will appreciate that a keyword search or refined search features are provided not only by Internet portals as most community websites have their own internal search mechanisms and systems. Thus the present invention is not limited in scope to search engine websites only, but can be readily adaptable to other community websites such as those commonly used by online auction companies, dating services, comparison-shopping, and phone book websites.

Additionally, one of ordinary skill in the art will appreciate that virtually any group of refined search terms can be used to create a more precise and effective search. In the present invention a search engine, Internet portal, or community website can choose to provide a refined search option that allows a user to enter additional criteria such as sex or zip codes or any additional data fields defined in the search mechanism which will return more accurate results. In a preferred embodiment of the present invention refined search terms are related to receiving member's geographic location or personal characteristics.

The typical search engine result (700) illustrates that paying advertisers are displayed along a column (701) located on the right hand side of an Internet browser page. In the desired search results page (702), paying advertisers are listed in a first series of horizontal rows (703) and are displayed along a column (704) located on the right hand side of an Internet browser page. Additional information supplied with the calling icons located displayed along a column (704) located on the right hand side of an Internet browser page may be the receiver's country and zip code, keywords, and fee scheme (flow and rate).

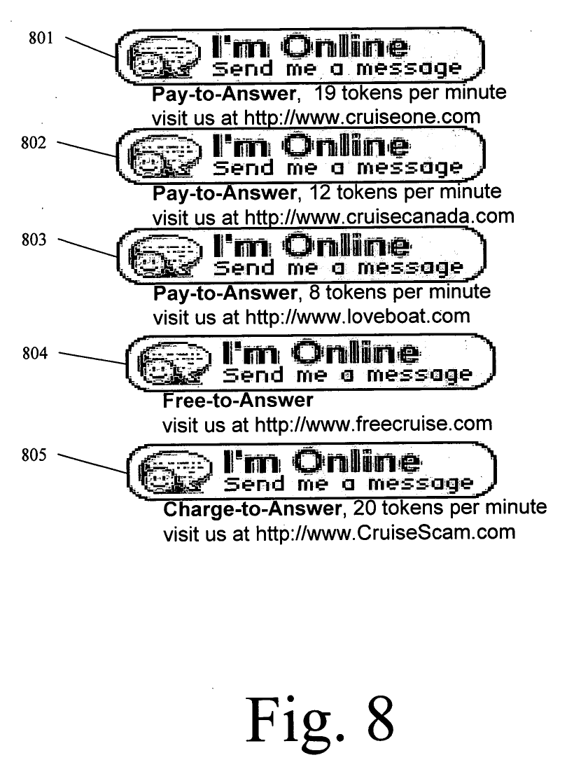

Now referring to FIG. 8, the ordering of the call icons (800) in a desired search result page are illustrated. Results may be returned in a search result page in several variations, preferably: pay-to-answer first (801, 802, and 803) with the higher rate on top (801); free-to-answer (804), then, lower rate on top; and charge-to-answer (805), then lower rate on top. The higher advertisers such as pay-to-answer providers (801, 802, and 803) are rewarded with their call icons appearing in a higher position.

One of ordinary skill in the art will appreciate the that logo appearance illustrated in FIGS. 7 and 8 is merely a few lines of code that users can cut and paste onto their own web pages. The icons may be selected for starting an IM session and the search engine provider creating these logos may collect referral fees.

FIG. 9 illustrates that of the 5 on-line advertising members returned by the search engine, three listed on the top are the higher advertisers such as pay-to-answer providers (801, 802, and 803) while there is one (801); free-to-answer (804) receiver and one charge-to-answer (805) receiver. The search engine provider sells advertisements with its search results pages and receives a portion of the IM fee flows from a successful connection in addition to advertisement fees that may take the form of keyword subscription.

In an alternative embodiment, members can create multiple identities (also known as an alias) and designate different fee schemes to each of the alias, in order to take full advantage of the multiple fee/charging schemes. For example a member could elect to have a master identity as a Charge-to-Answer Professional, charging $10 per minute, while at the same time posting a Pay-to-Answer alias to encourage people to chat with the member in French, which they might both be enthusiastically learning, by paying a flat rate of $1 per call. Under this format there is no conflict for a member to charge or pay for calls based on these two roles, because the callers will be calling the member from identity sources that describe the member differently, and know beforehand what the cost or benefit would be from making that call.

It is appreciated that the relationships for the parts of the invention, to include variation in database and subsystem configuration to detach them for each other and provide the possibilities to deploy the system in different locations and under different authorities with division of labor, are deemed readily apparent and obvious to one of ordinary skill in the art, and all equivalent relationships to those illustrated in the drawings and described in the above description are intended to be encompassed by the present invention.

In addition, other areas of art may benefit from this method and adjustments to the design are anticipated. Thus, the scope of the invention should be determined by the appended claims and their legal equivalents, rather than by the examples given.

1. Method for receiver self-priced multimedia communication comprising:
one or more members connected with the multimedia communication system via a multi-user network utilizing electronic devices that utilize browsers and installed communication client software;
the installed communication client software on an electronic device includes an instant messaging program;
the multimedia communication system is installed as a plug-in to said instant messaging program installed on an electronic device;
members subscribe to one or more keywords to establish relevance with keywords to be quarried by search engine users;
members choose a fee flow method and set per-pulse fee rate corresponding to each of members' keyword subscriptions;
members activate the client software and connect to communication subsystem to declare an on-line status and standby for communications;
users entering keywords into a search engine to find contents and on-line advertising members;
said search engine returning contents and a listing of on-line advertising members relevant to said keywords entered by said users.

2. The method for receiver self-priced multimedia communication of claim 1 wherein members purchase, via said transaction subsystem, a prepaid amount of service value.

3. The method for receiver self-priced multimedia communication of claim 2 wherein the said prepaid amount of service value in a member account may be used as payment for other services or goods outside of the multimedia communication system.

4. The method for receiver self-priced multimedia communication of claim 3 wherein the said prepaid amount of service value in the said member account may be increase by the transfer of a compatible monetary amount from an outside source.

5. The method for receiver self-priced multimedia communication of claim 3 wherein the said member account enables the said member to place a hold on the transfer of any funds for a set period of time or until a further action is taken.

6. The method for receiver self-priced multimedia communication of claim 1 wherein the communications via said multi-user network are completed through an instant messaging system.

7. The method for receiver self-priced multimedia communication of claim 1 wherein said search engine enables a refined search wherein said user enters profile data related to specific search criteria of said search engine.

8. The method for receiver self-priced multimedia communication of claim 7 wherein said refined search keywords are related to the said members' geographic location or personal characteristics.

9. The method for receiver self-priced multimedia communication of claim 8 wherein said search engine is a website with contents and one or more search mechanisms to search said contents.

10. The method for receiver self-priced multimedia communication of claim 7 wherein results are returned in a search result page such that higher paying advertising members are rewarded with their call icons appearing in a higher position.

11. The method for receiver self-priced multimedia communication of claim 10 wherein search results are ordered such that pay-to-answer advertising members are listed first or in a preferred position followed by free-to-answer advertising members and lastly by charge-to-answer advertising members.

12. The method for receiver self-priced multimedia communication of claim 1 wherein the fee flow method is a flat, one-time fee, set for one call.

13. The method for receiver self-priced multimedia communication of claim 1 wherein the fee flow method is a flexible fee that is calculated based on the duration of a call.

14. The method for receiver self-priced multimedia communication of claim 1 wherein the fee flow method is a flat, one-time set fee for a non-manned, auto-answered call, featuring a live feed for multimedia streaming of audio-visual content.

15. The method for receiver self-priced multimedia communication of claim 1 wherein the fee flow method is a flat one-time fee set for a non-manned, auto-answered call, featuring download of one or more files.

16. The method for receiver self-priced multimedia communication of claim 1 wherein the fee flow method is a flat or flexible fee, calculated for a call, featuring a real-time game.

17. The method for receiver self-priced multimedia communication of claim 1 wherein the fee flow method is any one of:
a flat, one-time fee, set for one call;
a flexible fee that is calculated based on the duration of a call;
a flat, one-time set fee for a non-manned, auto-answered call, featuring a live feed for multimedia streaming of audio-visual content;
a flat one-time fee set for a non-manned, auto-answered call, featuring download of one or more files; or
a flat or flexible fee, calculated for a call, featuring a real-time game.

18. The method for receiver self-priced multimedia communication of claim 17 wherein a secondary fee flow method occurs when a paying member gives payment, in the form of a tip, to a paid member upon the completion of a call, in addition to all other fee flows, either in conjunction with or in place of a rating system.

19. The method for receiver self-priced multimedia communication of claim 1 wherein members can create multiple identities and designate different fee flow methods to each of the identities created, in order to take full advantage of the multiple fee/charging schemes.
